(19) United States
(12) Patent Application Publication
(10) Pub. No.: US 2026/0348525 A1
(43) Pub. Date: Nov. 5, 2026

(54) APPARATUS', SYSTEMS AND METHODS FOR HANDLING PRESSURISED GAS

(71) Applicant: FLEXERGY LTD, Edinburgh (GB)

(72) Inventors: Paul John CODD, Edinburgh (GB); Tobias HOFMEISTER, Edinburgh (GB)

(21) Appl. No.: 19/488,559

(22) PCT Filed: May 30, 2024
(86) PCT No.: PCT/GB2024/051390

§ 371 Date: Nov. 26, 2025

(30) Foreign Application Priority Data
May 31, 2023 (GB) 2308141.7

(51) Int. Cl. F17C 5/06; F04B 35/00; F28C 3/00

(52) U.S. Cl. CPC F17C 5/06; F04B 35/008; F28C 3/005; F17C 2205/0138; F17C 2205/0142; F17C 2205/0146; F17C 2221/012; F17C 2223/0123; F17C 2223/036; F17C 2225/0123; F17C 2225/036; F17C 2227/0164; F17C 2227/0341; F17C 2265/015

(57) ABSTRACT

Apparatus' (10; 110; 210) for compressing a gas (G), comprises a first container arrangement (12; 112; 212) comprising one or more first containers (16A; 116A; 216A), and a fluid communication arrangement (18; 118; 218) configured to provide fluid communication between a source of a compression fluid C and the first container arrangement (12; 112; 212). The first container arrangement (12; 112; 212) is configured to receive the gas (G) to be pressurised. The apparatus (10; 110; 210) is configured and/or operable to direct the compression fluid (C) to the first container arrangement (12; 112; 212), the compression fluid (C) being incompressible or substantially incompressible so as to form a fluid piston acting on the gas (G) contained in the first container arrangement (14; 114; 214), thereby compressing the gas near-isothermally (G). Also disclosed is an apparatus for near-loss-less transferring of a pressurised gas (G).

### FIELD

This relates to apparatus', systems and methods for handling pressurised gas, in particular but not exclusively hydrogen gas. More particularly, aspects relate to apparatus', systems and methods for compressing a gas and to transferring and/or transporting a pressurised gas.

### BACKGROUND

In order to meet the World's present and future energy needs in an environmentally sustainable way, systems and methodologies utilising different energy carriers are being developed. One particular area of interest is in the development of systems which utilise pressurised hydrogen gas.

Pressurised gas handling systems are used extensively and form a critical part of the energy supply chain infrastructure across a number of industry sectors.

Current techniques for handling pressurised gas involve the use of piston compressors to first compress the gas. The pressurised gas is then transferred by a process of decanting between a donating container and a receiving container that leverages pressure differences between the containers.

However, despite widespread use of pressurised gas systems there remain a number of significant technical challenges, in particular when considering the development of systems for use with pressurised hydrogen.

For example, the use of piston compressors results in significant temperature increases in the gas being compressed. Given hydrogen's relatively low self-ignition temperature, from a safety perspective, it is required to intercool the gas between compression stages. The requirement to intercool the gas limits the compression ratio that can be achieved at any given stage, requiring that a greater number of stages is employed. The need for additional stages increases the capital expenditure (CAPEX) to construct and/or maintain the system and/or increases the footprint of the system. This in turn may limit the locations that such systems can be adopted.

Moreover, conventional piston compressors operate a relatively high RPM and/or require advanced manufacturing technology in their construction due amongst other things for the requirement for tight tolerances in their manufacture in order to function effectively. This too results in additional capital expenditure.

Conventional systems and techniques for the transfer of pressurised gas have a number of significant technical and practical drawbacks.

For example, the process of decanting between the donating and receiving containers is thermodynamically inefficient as high pressure gas entering a lower pressure container expands before being re-compressed as more high pressure gas enters the receiving container. This expansion and re-compression produces temperature effects, resulting in thermal and/or mechanical stresses on the containers which may, e.g. reduce the operational life of the containers and/or the system.

One feature of hydrogen is its low Joule-Thomson inversion temperature, meaning that its temperature increases during expansion. This, coupled with hydrogen's relatively low self-ignition temperature, requires that amongst other things gas transfer speed and pressure cascading must be carefully managed. The usual process for gas delivery involves a cascade in which vessels with higher pressure are filled first before going on to vessels with lower pressure. This approach is necessary as a pressure gradient is required for the gas transfer. It will be understood that this results in a complex system since each storage vessel has its own fill/pressure level. The expansion and recompression of the gas during this process causes thermodynamic irreversibilities. As a pressure gradient is necessary for the gas transfer the lowest pressure at the receiving site is the determining factor for how much gas can be delivered from the tube trailer, e.g. if the lowest pressure at the receiving site is 250 bar the tube trailer will leave the site with gas at a pressure of 250 bar, which produces transportation inefficiency as valuable product has not been able to be delivered. Alternatively, hydrogen is recompressed from a low pressure back to a high pressure at the delivery site, requiring a powerful compressor and using electricity from the grid, often at expensive rates and times of day.

Another challenge with conventional systems is that a significant quantity of pressurised gas is left in the delivery vehicle storage container, since in order to decant from the delivery vehicle storage container to the delivery container there must be sufficient pressure differential, this being determined by the lowest level of pressure to be delivered. Typically, the quantity of gas left may be as much as 50% of the storage capacity of the delivery vehicle's storage container. Amongst other things, this added load causes overall higher fuel consumption for the delivery journeys.

### SUMMARY

Aspects of the present disclosure relate to apparatus', systems and methods for handling gas, in particular but not exclusively hydrogen gas. More particularly, aspects relate to apparatus', systems and methods for compressing a gas and/or to apparatus', systems and methods for transferring a pressurised gas.

According to a first aspect, there is provided an apparatus for compressing a gas, comprising:
a first container arrangement comprising one or more first containers,
wherein the first container arrangement is configured to receive and/or store a gas to be pressurised;
a fluid communication arrangement configured to provide fluid communication between a source of a compression fluid and the first container arrangement,
wherein the apparatus is configured and/or operable to direct the compression fluid to the first container arrangement via said fluid communication arrangement, the compression fluid being incompressible or substantially incompressible so as to form a fluid piston acting on the gas contained in the first container arrangement, thereby compressing the gas contained in the first container arrangement.

In use, the apparatus is operable to direct an incompressible or substantially compression fluid from a source of the compression fluid to a first container arrangement, the compression fluid forming a fluid piston acting on the gas contained in the first container arrangement. Movement of the fluid piston reduces the volume and increases the pressure of the gas contained in the first container arrangement, thereby pressurising the gas, e.g. from an entry stage pressure to a target pressure at which it is desired to transport and/or otherwise handle the gas.

The present apparatus provides a number of significant benefits over conventional systems and methodologies.

For example, the apparatus facilitates near isothermal compression of the gas to be achieved. The apparatus obviates the requirement to decant between donating and receiving containers and so avoids the thermodynamic inefficiencies associated with conventional techniques. The apparatus also obviates the thermal and/or mechanical stresses on the containers which may otherwise reduce the operational life of the containers and/or the system. Moreover, no additional storage capacity for the compression fluid is required, as it is under constant use flowing between the first and second container arrangements. However, it will be understood that additional storage capacity, e.g. one or more buffer tanks, accumulators and/or reservoirs, may be provided.

As described above, the apparatus comprises a first container arrangement comprising one or more first containers.

The first container arrangement may comprise a single container or a plurality of containers.

Where the first container arrangement comprises a plurality of the containers, at least two of the containers may be arranged and/or fluidly connected in series. In some embodiments all of the containers of the first container arrangement may be arranged and/or fluidly connected in series.

Beneficially, the provision of two or more containers in series may facilitate favourable dynamic effects.

Alternatively or additionally, where the first container arrangement comprises a plurality of the containers, at least two of the containers may be arranged and/or fluidly connected in parallel. In some embodiments, all of the containers of the first container arrangement may be arranged and/or fluidly connected in parallel.

The one or more first containers may comprise or take the form of any suitable structure that the capacity to hold a gas under pressure, i.e. higher than atmospheric pressure or above-zero gauge pressure.

For example, at least one of the first containers may comprise or take the form of a vessel, e.g. a pressure vessel.

Alternatively or additionally, at least one of the first containers may comprise or take the form of: a tank; a pipe; a tube; a hose; an accumulator; a manifold or other suitable container.

The configuration, e.g. dimensions, structure, shape, materials, of the first containers may be selected according to the pressure requirements of the gas and/or compression fluid being handled. For example, the apparatus may comprise or may form part of a system comprising multiple stages, e.g. 2, 3, 4, 5, . . . n stages. For a lower pressure stage, the first containers may be configured with a relatively higher volume capacity than for higher pressure stages while for a higher pressure stage the first containers may be configured with a relatively lower volume capacity than for lower pressure stages.

The first container arrangement may comprise a first inlet. The first inlet may be coupled to a source of the gas. The first inlet may be configured and/or operable to act as a gas inlet, e.g. permitting and/or controlling the supply of the gas at entry pressure to the one or more containers. The first inlet may comprise, may be coupled to, or take the form of a control valve.

The first container arrangement may comprise a single first inlet or a plurality of first inlets. The first inlet (or where the apparatus comprises a plurality of the first inlets at least one of the first inlets) may permit and/or control the supply of the gas to one or more of the containers.

The first container arrangement may comprise a first outlet. The first outlet may be configured and/or operable to act as a gas outlet, e.g. permitting and/or controlling the egress of the gas at target pressure from the one or more containers. The first outlet may comprise, may be coupled to, or take the form of a control valve.

The first container arrangement may comprise a single first outlet or a plurality of the first outlets. The first outlet (or where the apparatus comprises a plurality of the first outlet at least one of the first outlets) may permit and/or control the egress of the gas from one or more of the first containers.

The first inlet may be defined as a low pressure gas inlet, i.e. permitting and/or controlling the supply of gas at a lower pressure than exits via the first outlet. The first outlet may be defined as a high pressure gas outlet, i.e. permitting and/or controlling the egress of gas at a higher pressure than the first inlet.

The first container arrangement may comprise a second inlet. The second inlet may be coupled to the source of the compression fluid. The second inlet may be configured and/or operable to act as a compression fluid inlet, e.g. permitting and/or controlling the supply of the compression fluid to the one or more containers. The second inlet may comprise, may be coupled to, or take the form of a control valve.

The first container arrangement may comprise a single second inlet or a plurality of the second inlets. The second inlet (or where the apparatus comprises a plurality of the second inlets at least one of the second inlets) may permit and/or control the supply of the compression fluid to one or more of the containers.

The first container arrangement may comprise a second outlet. The second outlet may be configured and/or operable to act as a compression fluid outlet, e.g. permitting and/or controlling the egress of the compression fluid from one or more of the containers. The second outlet may comprise, may be coupled to, or take the form of a control valve.

The first container arrangement may comprise a single second outlet or a plurality of the second outlets. The second outlet (or where the apparatus comprises a plurality of the second outlets at least one of the second outlets) may permit and/or control the egress of the compression fluid from one or more of the containers.

The second inlet may define a high pressure compression fluid inlet, i.e. permitting and/or controlling the supply of compression fluid at a higher pressure than exits via the second outlet and/or permitting and/or controlling the supply of compression fluid at higher pressure than the gas at entry. The second outlet may be defined as a low pressure compression fluid outlet, i.e. permitting and/or controlling the egress of the compression fluid at a lower pressure than the second inlet.

### Direct/Indirect Injection (Gas)

The apparatus may be configured and/or operable so that the gas to be pressurised is supplied, e.g. injected, directly into the first container arrangement.

Alternatively or additionally, the apparatus may be configured and/or operable so that the gas to be pressurised is supplied indirectly into at least one of the first containers of the first container arrangement. For example, the apparatus may comprise a manifold.

The apparatus may comprise a second container arrangement.

The second container arrangement may comprise one or more second containers.

The second container arrangement may be configured to receive and/or store compression fluid.

The apparatus may be configured and/or operable to direct the compression fluid from the second container arrangement to the first container arrangement via the fluid communication arrangement, the compression fluid being incompressible or substantially incompressible so as to form a fluid piston acting on the gas contained in the first container arrangement, thereby compressing the gas contained in the first container arrangement.

The apparatus may be configured and/or operable to direct a second volume of gas to be pressurised into the second container arrangement. In particular, the apparatus may be configured and/or operable to direct the second volume of gas to be pressurised into the second container arrangement as the compression fluid is being directed from the second container arrangement to the first container arrangement.

In use, the further volume of gas to be pressurised may occupy the volume previously occupied by the compression fluid in the second container arrangement.

It will be recognised that, in use, once the second container arrangement has directed all of the compression fluid contained therein to the first container arrangement and the second container arrangement is full of the further gas to be pressurised, the apparatus may be operable in reverse in a subsequent cycle of operation by directing the compression fluid from the first container arrangement (which in the subsequent cycle constitutes the second container arrangement) to the second container arrangement (which in the subsequent cycle constitutes the first container arrangement).

As described above, the apparatus comprises a second container arrangement comprising one or more second containers.

The second container arrangement may comprise a single container or a plurality of containers.

Where the second container arrangement comprises a plurality of the containers, at least two of the containers may be arranged and/or fluidly connected in series. In some embodiments all of the containers of the second container arrangement may be arranged and/or fluidly connected in series.

Beneficially, the provision of two or more containers in series may facilitate favourable dynamic effects.

Alternatively or additionally, where the second container arrangement comprises a plurality of the containers, at least two of the containers may be arranged and/or fluidly connected in parallel. In some embodiments, all of the containers of the second container arrangement may be arranged and/or fluidly connected in parallel.

The one or more containers of the second container arrangement may comprise or take the form of any suitable structure that the capacity to hold a gas under pressure, i.e. higher than atmospheric pressure or above-zero gauge pressure.

For example, at least one of the second containers may comprise or take the form of a vessel, e.g. a pressure vessel.

Alternatively or additionally, at least one of the second containers may comprise or take the form of: a tank; a pipe; a tube; a hose, an accumulator; a manifold or other suitable container.

The configuration, e.g. dimensions, structure, shape, materials, of the second containers may be selected according to the pressure requirements of the gas and/or compression fluid being handled. For example, the apparatus may comprise or may form part of a system comprising multiple stages, e.g. 2, 3, 4, 5, . . . n stages. For a lower pressure stage, the second containers may be configured with a relatively higher volume capacity than for higher pressure stages while for a higher pressure stage the second containers may be configured with a relatively lower volume capacity than for lower pressure stages.

The second container arrangement may comprise a first inlet. The first inlet may be coupled to a source of the gas. The first inlet may be configured and/or operable to act as a gas inlet, e.g. permitting and/or controlling the supply of the gas at entry pressure to the one or more containers. The first inlet may comprise, may be coupled to, or take the form of a control valve.

The second container arrangement may comprise a single first inlet or a plurality of first inlets. The first inlet (or where the apparatus comprises a plurality of the first inlets at least one of the first inlets) may permit and/or control the supply of the gas to one or more of the second containers.

The second container arrangement may comprise a first outlet. The first outlet of the second container may be configured and/or operable to act as a gas outlet, e.g. permitting and/or controlling the egress of the gas at target pressure from the one or more containers. The first outlet may comprise, may be coupled to, or take the form of a control valve. The second container arrangement may comprise a single first outlet or a plurality of the first outlets. The first outlet (or where the apparatus comprises a plurality of the first outlet at least one of the first outlets) may permit and/or control the egress of the gas from one or more of the containers.

The first inlet may be defined as a low pressure gas inlet, i.e. permitting and/or controlling the supply of gas at a lower pressure than exits via the first outlet. The first outlet may be defined as a high pressure gas outlet, i.e. permitting and/or controlling the egress of gas at a higher pressure than the first inlet.

The second container arrangement may comprise a second inlet. The second inlet may be coupled to the source of the compression fluid. The second inlet of the second container may be configured and/or operable to act as a compression fluid inlet, e.g. permitting and/or controlling the supply of the compression fluid to the one or more containers. The second inlet may comprise, may be coupled to, or take the form of a control valve.

The second container arrangement may comprise a single second inlet or a plurality of the second inlets. The second inlet (or where the apparatus comprises a plurality of the second inlets at least one of the second inlets) may permit and/or control the supply of the compression fluid to one or more of the second containers.

The second container arrangement may comprise a second outlet. The second outlet of the second container may be configured and/or operable to act as a compression fluid outlet, e.g. permitting and/or controlling the egress of the compression fluid from one or more of the containers. The second outlet may comprise, may be coupled to, or take the form of a control valve.

The second container arrangement may comprise a single second outlet or a plurality of the second outlets. The second outlet (or where the apparatus comprises a plurality of the second outlets at least one of the second outlets) may permit and/or control the egress of the compression fluid from one or more of the second containers.

The second inlet may define a high pressure compression fluid inlet, i.e. permitting and/or controlling the supply of compression fluid at a higher pressure than exits via the second outlet and/or permitting and/or controlling the supply of compression fluid at higher pressure than the gas at entry. The second outlet may be defined as a low pressure compression fluid outlet, i.e. permitting and/or controlling the egress of the compression fluid at a lower pressure than the second inlet.

The apparatus may be configured and/or operable so that the gas to be pressurised is supplied, e.g. injected, directly into the second container arrangement.

Alternatively or additionally, the apparatus may be configured and/or operable so that the gas to be pressurised is supplied indirectly into at least one of the second containers of the second container arrangement. For example, the apparatus may comprise a manifold.

One or more of the second containers may be identical or substantially identical to the first container. Alternatively, one or more of the second containers may be of a different configuration to the first containers.

The configuration, e.g. dimensions, structure, shape, materials, of the second containers may be selected according to the pressure requirements of the gas and/or compression fluid being handled. For example, the apparatus may comprise or may form part of a system comprising multiple stages, e.g. 2, 3, 4, 5, . . . n stages. For a lower pressure stage, the second containers may be configured with a relatively higher volume capacity than for higher pressure stages while for a higher pressure stage the second containers may be configured with a relatively lower volume capacity than for lower pressure stages.

The apparatus may comprise, may be coupled to or operatively associated with a cooling arrangement.

As described above, conventional techniques for the compression of a gas result in increase in temperature of the gas. For example, the use of piston compressors results in significant temperature increases in the gas being compressed. Given hydrogen's relatively low self-ignition temperature, from a safety perspective, it is required to intercool the gas between compression stages. The requirement to intercool the gas limits the compression ratio that can be achieved at any given stage, requiring that a greater number of stages is employed. The need for additional stages increases the capital expenditure (CAPEX) to construct and/or maintain the system and/or increases the footprint of the system. This in turn may limit the locations that such systems can be adopted.

Beneficially, the cooling arrangement prevents or mitigates the detrimental effects which may otherwise result from increases in temperature of the gas, in particular hydrogen gas.

The cooling arrangement may comprise or take the form of a spray cooling arrangement.

Alternatively or additionally, the cooling arrangement may be configured and/or operable to form a layer, e.g. film, of cooling fluid on the interior surface of one or more of the first containers of the first container arrangement and/or one or more of the second containers of the second container arrangement.

The cooling arrangement may be configured and/or operable to direct a cooling fluid into the first container arrangement and/or the second container arrangement.

In use, the cooling arrangement may be configured and/or operable to direct the cooling fluid into whichever of the first container arrangement and the second container arrangement is being utilised to compress the gas to be pressurised.

The apparatus may comprise, may be coupled to or operatively associated with a source of the cooling fluid. The apparatus may be coupled to the source of the cooling fluid by a cooling fluid communication arrangement.

The apparatus may comprise one or more cooling fluid inlets. The one or more cooling fluid inlets may be coupled to a source of the cooling fluid. The cooling fluid inlets may be configured and/or operable to permit and/or control the supply of the cooling fluid to the first container arrangement and/or the second container arrangement. At least one of the cooling fluid inlets may comprise, may be coupled to, or take the form of a control valve. At least one of the cooling fluid inlets may comprise, may be coupled to, or take the form of a nozzle, e.g. spray nozzle, for directing the cooling fluid into one or more of the first containers of the first container arrangement and/or one or more of the second containers of the second container arrangement.

The apparatus may comprise one or more cooling fluid outlets. The one or more cooling fluid outlets may be configured and/or operable to permit and/or control the egress of the cooling fluid from the first container arrangement and/or the second container arrangement. At least one of the cooling fluid outlets may comprise, may be coupled to, or take the form of a control valve.

As will be described further below, the apparatus may comprise a separator arrangement. In such embodiments, the one or more cooling fluid outlets may facilitate removal of the cooling fluid from one or more of the first containers of the first container arrangement and/or one or more of the second containers of the second container arrangement.

The cooling fluid may comprise or take the form of the compression fluid, e.g. cooled compression fluid. Alternatively, the cooling fluid may comprise or take the form of another suitable coolant fluid.

The cooling fluid may comprise or take the form of water.

The cooling fluid may comprise or take the form of a glycol, e.g. ethylene glycol.

The cooling arrangement may be configured and/or operable to direct a continuous spray of cooling fluid into whichever of the first container arrangement and the second container arrangement is being utilised to compress the gas to be pressurised.

The cooling arrangement may be configured and/or operable to increase the volume of cooling fluid as pressure of the gas increases as a result of its compression by the compression fluid.

Beneficially, this maintains the isothermal condition of the process.

In particular embodiments, the cooling arrangement may be configured and/or operable to seed the cooling fluid into the first and/or second container arrangement, i.e. whichever of the first or second container arrangement is being utilised to compress the gas. The cooling fluid may be seeded before compression of the gas starts. The cooling fluid may be seeded at any stage prior to completion of the compression of the gas.

Beneficially, this seeding of cooling fluid facilitates an even distribution of cooling fluid in the gas to be pressurised from the start of the gas compression phase.

In particular embodiments, the cooling fluid may be directed into the top or a top portion of the first container arrangement and/or second container arrangement.

The first container may further comprise an inlet arrangement for receiving the cooling fluid therethrough. The inlet arrangement may comprise one or more inlets.

In some embodiment, the first container may further comprise an outlet arrangement for directing the cooling fluid from the first container. The outlet arrangement may comprise one or more outlets.

The second container may further comprise an inlet arrangement for receiving the cooling fluid therethrough. The inlet arrangement may comprise one or more inlets.

In some embodiment, the second container may further comprise an outlet arrangement for directing the cooling fluid from the second container. The outlet arrangement may comprise one or more outlets.

The apparatus may be configured and/or operable so that the cooling fluid is supplied, e.g. injected, directly into the first container arrangement and/or second container arrangement.

Alternatively or additionally, the apparatus may be configured and/or operable to that the cooling fluid is supplied indirectly to at least one of the containers of the first container arrangement and/or the second container arrangement.

The cooling fluid may form or form part of the compression fluid. For example, in some instances, in particular but not exclusively in higher pressure applications or stages, the supply of the cooling fluid may increase the pressure of the gas by an amount sufficient to compress the gas to the target pressure.

The apparatus may comprise a separation arrangement.

The separation arrangement may be configured and/or operable to separate the gas to be pressurised from the compression fluid forming the liquid piston.

The separation arrangement may comprise or take the form of a mechanical separator member.

Alternatively or additionally, the separation arrangement may comprise or take the form of a chemical separator.

The apparatus may comprise, may be coupled to or operatively associated with a pump arrangement.

The pump arrangement may comprise a single pump or a plurality of pumps.

Beneficially, the configuration of the apparatus, e.g. by transferring and/or circulating the gas and/or compression fluid between the first container arrangement and the second container arrangement, and vice-versa, reduces the energy requirements for the pump arrangement since the pump arrangement is required only to initiate flow of the fluids.

The apparatus may comprise, may be coupled to or operatively associated with a heat exchanger arrangement.

The heat exchanger arrangement may comprise a single heat exchanger or a plurality of heat exchangers.

The apparatus may comprise or may be coupled to one or more buffer tanks.

The buffer tanks may be configured and/or operable to contain a supply of compression fluid.

The one or more buffer tanks may comprise or form a reservoir or accumulator.

The apparatus may comprise, may be coupled or operatively associated with a control system.

The control system, or part of the control system, may form part of the apparatus.

The control system may form part of the apparatus. For example, the control system may comprise or take the form of an onboard, e.g. embedded, control system.

The control system may comprise one or more programmable logic controllers (PLC), one or more programmable automation controllers (PAC), one or more microcontrollers, or other suitable controllers.

The control system, or part of the control system, may be coupled to or operatively associated with the apparatus. For example, the control system may be located at one or more remote location. The remote location may comprise or take the form of a mobile device such as tablet, mobile phone or the like. Alternatively or additionally, the remote location may comprise or take the form of a control room. Alternatively or additionally, the remote location may comprise or take the form of a data store, such as an online data store.

The apparatus may be configured to transmit information to and/or receive information from the control system.

The control system may be configured and/or operable to permit real time or near real time control of the apparatus.

The apparatus may comprise, may be coupled to or operatively associated with a sensor arrangement.

The sensor arrangement may comprise one or more temperature sensors.

The sensor arrangement may comprise one or more pressure sensors.

The sensor arrangement may comprise or more flow rate sensors.

The sensor arrangement may comprise one or more sensors configured and/or operable to measure the wetness of the gas, the compression fluid and/or the cooling fluid.

The apparatus may comprise or take the form of a wireless communication arrangement. The wireless communication arrangement may comprise a radio frequency communication arrangement. The communication arrangement may comprise or take the form of a transmitter or transceiver.

The communication arrangement may comprise or take the form of a wired communication arrangement. The wired communication arrangement may comprise or take the form of an electric wire and/or optical fibre communication arrangement.

The communication arrangement may comprise or take the form of a two-way communication arrangement. The communication arrangement may comprise or take the form of a transceiver.

The compression fluid may comprise or take the form of water.

The compression fluid may comprise or take the form of a glycol, e.g. ethylene glycol.

According to a second aspect, there is provided a system for compressing a gas comprising one or more apparatus according to the first aspect.

According to a third aspect, there is provided a method for compressing a gas, using the apparatus of the first aspect or the system of the second aspect.

According to a fourth aspect, there is provided an apparatus for transferring a pressurised gas, comprising:
a first container arrangement comprising one or more first containers, wherein the first container arrangement is configured to receive and/or store the pressurised gas to be transferred; and
a fluid communication arrangement configured to provide fluid communication between a supply of a compression fluid and the first container arrangement,
wherein the apparatus is configured and/or operable to direct the compression fluid to the first container arrangement via said fluid communication arrangement, the compression fluid being incompressible or substantially incompressible so as to form a fluid piston acting on the gas contained in the first container arrangement, thereby transferring the pressurised gas from the first container arrangement.

In use, the first container arrangement may define a gas donor of the apparatus, i.e. the first container arrangement donating the pressurised gas in response to receiving the compression fluid.

The present apparatus provides a number of significant benefits over conventional systems and methodologies.

For example, as described above, in conventional systems for transferring pressurised gas the process of decanting between the donating and receiving containers is thermodynamically inefficient and creates thermal irreversibilities, dissipating energy through entropy as high pressure gas entering a lower pressure container expands before being re-compressed as more high pressure gas enters the receiving container. This expansion and re-compression produces temperature effects, resulting in thermal and/or mechanical stresses on the containers which may, e.g. reduce the operational life of the containers and/or the system. One feature of hydrogen is its low Joule-Thomson inversion temperature, meaning that its temperature increases during expansion. This, coupled with hydrogen's relatively low self-ignition temperature, requires that amongst other things gas transfer speed and pressure cascading must be carefully managed. Moreover, a hydrogen gas delivery vehicle delivering to a number of delivery sites would need to plan or alter its route in order to deliver first to those sites requiring a higher pressure gas delivery, e.g. gas to be stored at a pressure of 750 bar, before those sites requiring a lower pressure gas delivery, e.g. gas to be stored at a pressure of 350 bar, since the pressure in the storage container would gradually decrease as the hydrogen is delivered. Another challenge with conventional systems is that a significant quantity of pressurised gas is left in the delivery vehicle storage container, since in order to decant from the delivery vehicle storage container to the delivery container there must be sufficient pressure differential, this being determined by the lowest level of pressure to be delivered. Typically, the quantity of gas left may be as much as 50% of the storage capacity of the delivery vehicle storage container.

The present apparatus obviates or at least mitigates these shortcomings.

The container arrangement described above may define a first container arrangement of the apparatus and the apparatus may comprise a second container arrangement. The second container arrangement may comprise one or more second containers.

The second container arrangement may be configured to receive and/or store the compression fluid.

In use, the second container arrangement may define a gas receiver of the apparatus, i.e. the second container arrangement receives the pressurised gas in response to supplying the compression fluid.

The apparatus may be configured and/or operable to direct the compression fluid from the second container arrangement to the first container arrangement via the fluid communication arrangement, the compression fluid being incompressible or substantially incompressible so as to form a fluid piston acting on the gas contained in the first container arrangement, thereby transferring the pressurised gas from the first container arrangement. The pressurised gas transferred from the first container arrangement may be transferred to the second container arrangement.

In use, the further volume of gas to be pressurised may occupy the volume previously occupied by the compression fluid in the second container arrangement.

It will be recognised that, in use, the apparatus may be operable in reverse in a subsequent cycle of operation by directing the compression fluid from the first container arrangement (which in the subsequent cycle constitutes the second container arrangement) to the second container arrangement (which in the subsequent cycle constitutes the first container arrangement).

Beneficially, the principle of donating the pressurised gas in response to receiving the compression fluid may be utilised through

According to a fifth aspect, there is provided a system for transferring a pressurised gas using the apparatus of the fourth aspect.

According to a sixth aspect, there is provided a method for transferring a pressurised gas, using the apparatus of the fourth aspect or the system of the fifth aspect.

According to a seventh aspect, there is provided an apparatus for extracting heat from a gas in a gas compression system, comprising:
a container arrangement comprising one or more first containers,
wherein the container arrangement is configured to receive and/or store a gas to be pressurised; and
a fluid communication arrangement configured to provide fluid communication between a source of cooling fluid and the first container arrangement,
wherein the apparatus is configured and/or operable to direct the cooling fluid to the first container arrangement via said fluid communication arrangement, the cooling fluid configured and/or operable to extract heat from the gas contained in the first container arrangement.

The apparatus may be configured and/or operable to direct the cooling fluid into the container arrangement before, during and/or after the gas is compressed.

The apparatus may comprise a cooling arrangement, such as the cooling arrangement described above with respect to the first aspect.

As described above, conventional techniques for the compression of a gas result in increase in temperature of the gas. For example, the use of piston compressors results in significant temperature increases in the gas being compressed. Given hydrogen's relatively low self-ignition temperature, from a safety perspective, it is required to intercool the gas between compression stages. The requirement to intercool the gas limits the compression ratio that can be achieved at any given stage, requiring that a greater number of stages is employed. The need for additional stages increases the capital expenditure (CAPEX) to construct and/or maintain the system and/or increases the footprint of the system. This in turn may limit the locations that such systems can be adopted.

Beneficially, the cooling arrangement prevents or mitigates the detrimental effects which may otherwise result from increases in temperature of the gas, in particular hydrogen gas.

According to an eighth aspect, there is provided a system for extracting heat from a gas in a gas compression system, comprising the apparatus of the seventh aspect.

According to a ninth aspect, there is provided a method of extracting heat from a gas in a gas compression system, comprising the apparatus of the seventh aspect or the system of the eighth aspect.

The invention is defined by the appended claims. However, for the purposes of the present disclosure it will be understood that any of the features defined above or described below may be utilised in isolation or in combination. For example, features described above in relation to one of the above aspects or below in relation to the detailed description below may be utilised in any other aspect, or together form a new aspect.

### BRIEF DESCRIPTION OF THE DRAWINGS

These and other aspects will now be described, by way of example only, with reference to the accompanying drawings, in which:

FIG. 1 shows an apparatus for compressing a gas;

FIG. 2 is a graph showing the temperature of the gas G and the cooling fluid F during the compression cycle;

FIG. 3 shows a diagrammatic view of an alternative apparatus for compressing a gas;

FIG. 4 shows a diagrammatic view of the first container arrangement of the apparatus shown in FIG. 3;

FIG. 5 shows a diagrammatic view of the second container arrangement of the apparatus shown in FIG. 3;

FIG. 6 shows a diagrammatic view illustrating the phase synching of the containers arrangements of the apparatus shown in FIG. 3, during the compression process;

FIG. 7 shows an alternative apparatus for compressing a gas;

FIG. 8 shows an alternative apparatus for compressing a gas;

FIG. 9 shows part of an alternative apparatus for compressing a gas, comprising a manifold for pre-mixing the gas and the cooling fluid;

FIG. 10 shows part of an alternative apparatus for compressing a gas, comprising a manifold for pre-mixing the gas and the cooling fluid;

FIG. 11 shows an apparatus for transferring a pressurised gas;

FIG. 12 shows a module of the apparatus shown in FIG. 11;

FIG. 13 shows another module of the apparatus shown in FIG. 11;

FIG. 14 shows an alternative apparatus for transferring a pressurised gas;

FIG. 15 shows a module of the apparatus shown in FIG. 14; and

FIG. 16 shows a diagrammatic view of a system for compressing and transferring a pressurised gas.

### DETAILED DESCRIPTION OF THE DRAWINGS

As noted above, aspects of the present disclosure relate to apparatus', systems and methods for handling gas, in particular but not exclusively hydrogen gas. More particularly, aspects relate to apparatus', systems and methods for compressing a gas and/or to apparatus', systems and methods for transferring a pressurised gas.

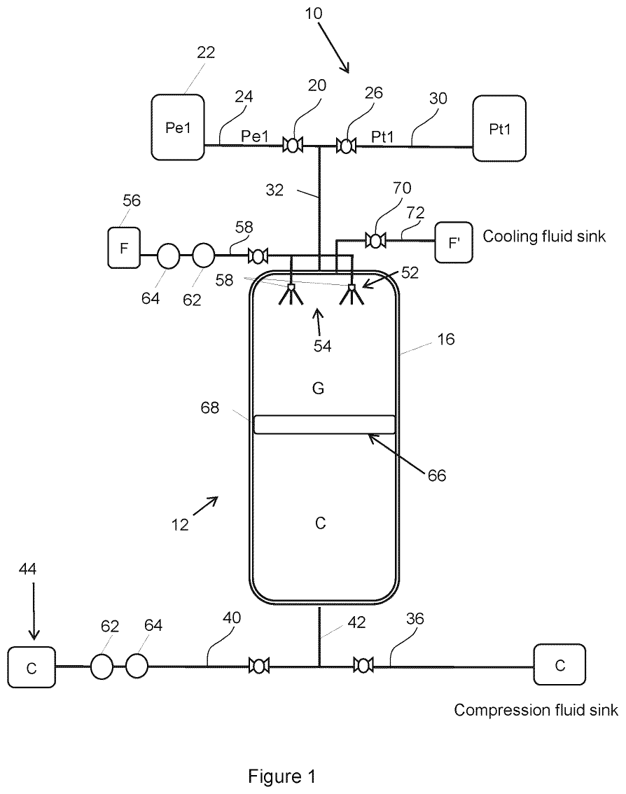

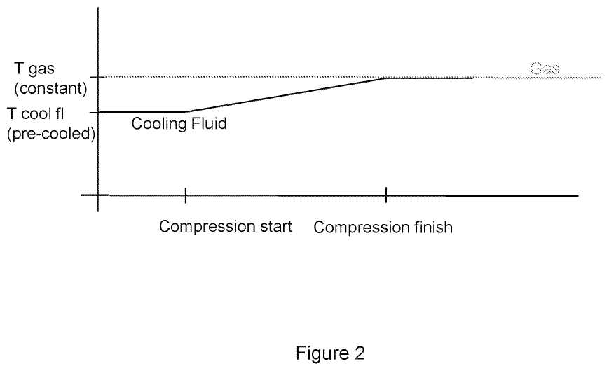

The apparatus' for compressing the gas may take a number of different forms. For example, and as will be described further below, FIG. 1 of the accompanying drawings shows a diagrammatic view of an apparatus 10 for compressing a gas G which utilises a single container arrangement 12 whereas FIGS. 2 to 7 show alternative apparatus' 110, 210, 310 which utilise a first container arrangement 112,212,312 and second container arrangement 114,214,314.

As shown in FIG. 1, the apparatus 10 comprises a container arrangement, generally denoted 12. In the illustrated apparatus 10, the container arrangement 12 comprises a container 16. The container 16 is configured to receive and/or contain the gas G to be pressurised.

The apparatus 10 further comprises a fluid communication arrangement, generally denoted 18, which is configured to provide fluid communication between the first container 16 and a source 44 of compression fluid C.

The apparatus 10 is configured and/or operable to direct the compression fluid C from the source 44 to the container 16 via the fluid communication arrangement 18, the compression fluid C being incompressible or substantially incompressible so as to form a fluid piston acting on the gas G contained in the container 16, thereby compressing the gas G contained in the container 16.

In use, the apparatus 10 is operable to direct an incompressible or substantially compression fluid C to the container arrangement 12, the compression fluid C forming a fluid piston acting on the gas G contained in the container arrangement 12. Movement of the fluid piston reduces the volume and increases the pressure of the gas G contained in the container 16, thereby pressurising the gas G from an entry stage pressure Pe1 to a target pressure Pt1.

As shown in FIG. 1, the container 16 comprises a first inlet 20 which is configured and/or operable to act as a gas inlet, e.g. low pressure gas inlet. In the illustrated apparatus 10, the first inlet 20 comprises, is coupled to or takes the form of a control valve and is coupled to a source 22 of gas at entry pressure Pe via a conduit 24.

The container 16 comprises a first outlet 26 which is configured and/or operable to act as a gas outlet, e.g. high pressure gas outlet. In use, the first outlet 26 is operable to direct pressurised gas at target pressure Pt1 from the container 16. In the illustrated apparatus 10, the first outlet 26 comprises, is coupled to or takes the form of a control valve and controls access to an outlet conduit 30.

As shown, in the apparatus 10 the first inlet 20 and the first outlet 26 share a common conduit 32 into/out from the container 16. However, it will be understood that the first inlet 20 and first outlet 26 may alternatively be directly coupled and/or form part of the container 16 and/or may be coupled to the first container 16 via separate conduits.

The container 16 further comprises a second inlet 34 which is configured and/or operable to act as a compression fluid inlet. In use, the second inlet 34 is operable to provide fluid communication of the compression fluid C from/to the source 44 via a fluid conduit 36 of the fluid communication arrangement 18. In the illustrated apparatus 10, the second inlet 34 comprises, is coupled to or takes the form of a control valve.

The container 16 further comprises a second outlet 38 which is configured and/or operable to act as a compression fluid outlet. In use, the second outlet 38 is operable to provide fluid communication of the compression fluid from the container 16 via a fluid conduit 40. In the illustrated apparatus 10, the second outlet 38 comprises, is coupled to or takes the form of a control valve.

As shown, in the apparatus 10 the second inlet 34 and the second outlet 38 share a common conduit 42 into/out from the container 16. However, it will be understood that the second inlet 34 and second outlet 38 may alternatively be directly coupled and/or form part of the container 16 and/or may be coupled to the container 16 via separate conduits.

As shown in FIG. 1, the illustrated apparatus 10 further comprises a pump 48 and a heat exchanger 50 on the conduit 36. However, where the compression fluid C is supplied from a source 44 at high pressure, the pump 48 and heat exchanger 50 may be omitted.

As shown in FIG. 1, the apparatus 10 further comprises a cooling arrangement, generally denoted 52.

Beneficially, the cooling arrangement 52 prevents or mitigates the detrimental effects which may otherwise result from increases in temperature of the gas, in particular those associated with hydrogen gas.

As shown, the cooling arrangement 52 comprises or take the form of a spray cooling arrangement.

The cooling arrangement 52 is configured and/or operable to direct a cooling fluid F into the container arrangement 12.

As shown in FIG. 1, the cooling fluid F is directed into the top of the container 16, the container 16 comprising an inlet arrangement 54 for receiving the cooling fluid F from a source 56 of the cooling fluid F via a fluid conduit 58. Where the cooling fluid F comprises or takes the form of cooled compression fluid C, the source 356 may be the same source 44 described above. In the illustrated apparatus 10, the inlet arrangement 54A comprises one or more inlets 58A in the form of nozzles.

As shown, the cooling arrangement 52 further comprises a pump 62 and a heat exchanger 64 on the conduit 58.

As shown in FIG. 1, the illustrated apparatus 10 comprises a separation arrangement, generally denoted 66.

The separation arrangement 66 is configured and/or operable to separate the gas G to be pressurised from the compression fluid C forming the liquid piston.

In the illustrated apparatus 10, the separation arrangement 66 comprises a mechanical separator member 68.

In the illustrated apparatus 10, the first container 16 further comprises an outlet 70. The outlet 70 is configured and/or operable to directing the cooling fluid F from the container 16 via a conduit 72 to a cooling fluid sink. In the illustrated apparatus 10, the outlet 70 comprises, is coupled to or takes the form of a control valve.

FIG. 2 is a graph showing the temperature of the gas G and the cooling fluid F during the compression cycle. As shown, the temperature of the cooling fluid F increases during the compression cycle. The temperature of the gas G is maintained constant.

It will be understood that various modifications may be made without departing from the scope of the claimed invention.

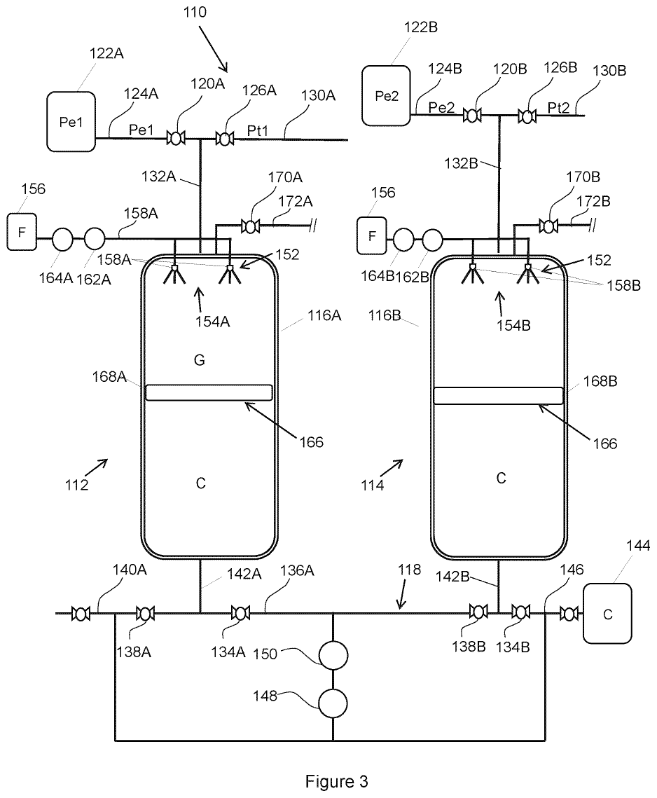

For example, FIG. 3 of the accompanying drawings shows a diagrammatic view of an alternative apparatus, generally denoted 110, for compressing a gas G. In the illustrated apparatus 110, the gas G takes the form of hydrogen gas. However, it will be understood that the apparatus 110 may be utilised to handle other gasses utilised in industrial processes.

As shown in FIG. 3, the apparatus 110 comprises a first container arrangement, generally denoted 112 (shown on the left in FIG. 3), and a second container arrangement, generally denoted 114 (shown on the right in FIG. 3). In the illustrated apparatus 110, the first container arrangement 112 comprises a first container 116A and the second container arrangement 114 comprises a second container 116B. The first container 116A is configured to receive and/or contain the gas G to be pressurised. The second container 116B contains and/or is configured to receive compression fluid C. The apparatus 110 further comprises a fluid communication arrangement, generally denoted 118, which is configured to provide fluid communication between the first container 116A and the second container 116B.

As will be described further below, the apparatus 110 is configured and/or operable to direct the compression fluid C from the second container 116B to the first container 116A via the fluid communication arrangement 118, the compression fluid C being incompressible or substantially incompressible so as to form a fluid piston acting on the gas G contained in the first container 116A, thereby compressing the gas G contained in the first container 116A.

In use, the apparatus 110 is operable to direct an incompressible or substantially compression fluid C from the second container arrangement 114 to the first container arrangement 112, the compression fluid C forming a fluid piston acting on the gas G contained in the first container arrangement 112. Movement of the fluid piston reduces the volume and increases the pressure of the gas G contained in the first container 116A, thereby pressurising the gas G from an entry stage pressure Pe1 to a target pressure Pt1.

In some instances, the pressurised gas G at target pressure Pt1 is then directed for storage, transport and/or other handling processes.

Alternatively, the pressurised gas G at target pressure Pt1 may then be directed to a subsequent stage where the pressure of the gas G is further increased.

The apparatus 110 is configured and/or operable to direct a second volume of gas G to be pressurised at entry pressure Pe2, which may be at the same or a different entry pressure to Pe1, into the second container arrangement 114 as the compression fluid C is directed from the second container arrangement 114 to the first container arrangement 112. The further volume of gas G to be pressurised may occupy the volume previously occupied by the compression fluid C in the second container 116B.

It will be recognised that, in use, once the second container arrangement 114 has directed all of the compression fluid C contained therein to the first container arrangement 112 and the second container arrangement 114 is full of the further gas G to be pressurised, the apparatus 110 may be operable in reverse in a subsequent cycle of operation by directing the compression fluid C from the first container arrangement 112 (which in the subsequent cycle constitutes the second container arrangement) to the second container arrangement 114 (which in the subsequent cycle constitutes the first container arrangement).

The present apparatus 110 provides a number of significant benefits over conventional systems and methodologies.

For example, the apparatus 110 facilitates near isothermal compression of the gas to be achieved. The apparatus 110 obviates the requirement to decant between donating and receiving containers and so avoids the thermodynamic inefficiencies associated with conventional techniques. The apparatus 110 also obviates the thermal and/or mechanical stresses on the containers which may otherwise reduce the operational life of the containers and/or the system. Moreover, no additional storage capacity for the compression fluid C is required, as it is under constant use flowing between the first and second container arrangements 112, 114.

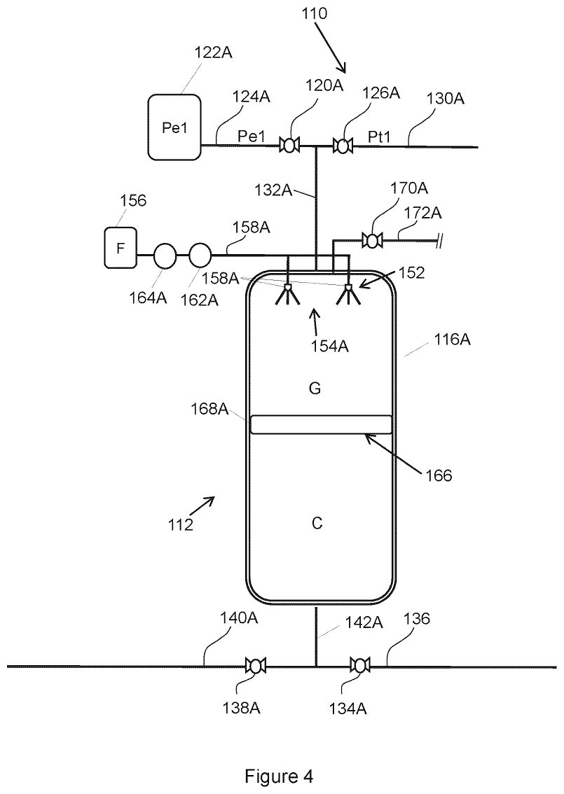

Referring now also to FIG. 4 of the accompanying drawings, which shows an enlarged view of the first container 116A, the first container 116A comprises a first inlet 120A which is configured and/or operable to act as a gas inlet, e.g. low pressure gas inlet. In the illustrated apparatus 110, the first inlet 120A comprises, is coupled to or takes the form of a control valve and is coupled to a source 122A of gas at entry pressure Pe via a conduit 124A.

The first container 116A comprises a first outlet 126A which is configured and/or operable to act as a gas outlet, e.g. high pressure gas outlet. In use, the first outlet 126A is operable to direct pressurised gas at target pressure Pt1 from the first container 116A. In the illustrated apparatus 110, the first outlet 126A comprises, is coupled to or takes the form of a control valve and controls access to an outlet conduit 130A.

As shown, in the apparatus 110 the first inlet 120A and the first outlet 126A share a common conduit 132A into/out from the first container 116A. However, it will be understood that the first inlet 120A and first outlet 126A may alternatively be directly coupled and/or form part of the first container 116A and/or may be coupled to the first container 116A via separate conduits.

The first container 116A further comprises a second inlet 134A which is configured and/or operable to act as a compression fluid inlet. In use, the second inlet 134A is operable to provide fluid communication of the compression fluid from/to the second container 116B via a fluid conduit 136 of the fluid communication arrangement 118. In the illustrated apparatus 110, the second inlet 134A comprises, is coupled to or takes the form of a control valve.

The first container 116A further comprises a second outlet 138A which is configured and/or operable to act as a compression fluid outlet. In use, the second outlet 138A is operable to provide fluid communication of the compression fluid (and, where applicable, cooling fluid as will be described below) from the first container 116A via second container 116B via a fluid conduit 140A. In the illustrated apparatus 110, the second outlet 138A comprises, is coupled to or takes the form of a control valve.

As shown, in the apparatus 110 the second inlet 134A and the second outlet 138A share a common conduit 142A into/out from the first container 116A. However, it will be understood that the second inlet 134A and second outlet 138A may alternatively be directly coupled and/or form part of the first container 116A and/or may be coupled to the first container 116A via separate conduits.

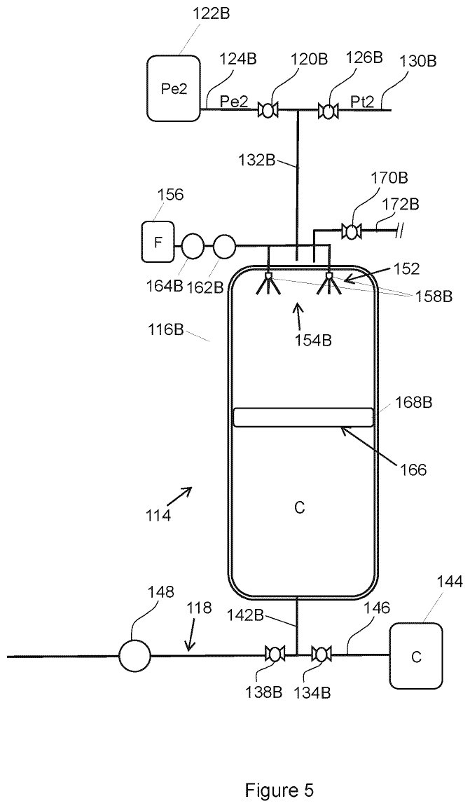

Referring now also to FIG. 5 of the accompanying drawings, which shows an enlarged view of the second container 116B, the second container 116B comprises a first inlet 120B which is configured and/or operable to act as a gas inlet, e.g. low pressure gas inlet. In the illustrated apparatus 110, the first inlet 120B comprises, is coupled to or takes the form of a control valve and is coupled to a source 122B of gas at entry pressure Pe2 via a conduit 124B.

The second container 116B comprises a first outlet 126B which is configured and/or operable to act as a gas outlet, e.g. high pressure gas outlet. In use, the first outlet 126B is operable to direct pressurised gas at target pressure Pt2 from the second container 116B.

In the illustrated apparatus 110, the first outlet 126B comprises, is coupled to or takes the form of a control valve and controls access to an outlet conduit 130B.

As shown, in the illustrated apparatus 110 the first inlet 120B and the first outlet 126B share a common conduit 132B into/out from the second container 116B. However, it will be understood that the first inlet 120B and the first outlet 126B may alternatively be directly coupled and/or form part of the second container 116B and/or may be coupled to the second container 116B via separate conduits.

The second container 116B further comprises a second inlet 134B which is configured and/or operable to act as a compression fluid inlet. In the illustrated apparatus 110, the second inlet 134B comprises, is coupled to or takes the form of a control valve and is coupled to a source 144 of compression fluid C via a fluid conduit 146.

The second container 116B further comprises a second outlet 138B which is configured and/or operable to act as a compression fluid outlet. In use, the second outlet 138B is operable to provide fluid communication of the compression fluid C (and, where applicable, cooling fluid as will be described below) from the second container 116B to the first container 116A.

In the illustrated apparatus 110, the second inlet 134B and the second outlet 138B share a common conduit 142B into/out from the second container 116B. However, it will be understood that the second inlet 134B and second outlet 138B may alternatively be directly coupled and/or form part of the first container 116B and/or may be coupled to the first container 116B via separate conduits.

As noted above, once the second container arrangement 114 has directed all of the compression fluid C contained therein to the first container arrangement 112 and the second container arrangement 112 is full of the further gas to be pressurised, the apparatus 110 may be operable in reverse in a subsequent cycle of operation by directing the compression fluid C from the first container arrangement 112 (which in the subsequent cycle constitutes the second container arrangement) to the second container arrangement 114 (which in the subsequent cycle constitutes the first container arrangement).

Thus, it will be recognised that in this alternate mode the second outlet 138B acts as the second inlet.

As shown in FIG. 3, the illustrated apparatus 110 further comprises a pump 148 and a heat exchanger 150 on the conduit 136. However, where the compression fluid C is supplied from a source 144 at high pressure and lower temperature, the pump 148 and heat exchanger 150 may be omitted.

As shown in FIGS. 1 to 3, the apparatus 110 further comprises a cooling arrangement, generally denoted 152.

As described above, conventional techniques for the compression of a gas result in increase in temperature of the gas. For example, the use of piston compressors results in significant temperature increases in the gas being compressed. Given hydrogen's relatively low self-ignition temperature, from a safety perspective, it is required to intercool the gas between compression stages. The requirement to intercool the gas limits the compression ratio that can be achieved at any given stage, requiring that a greater number of stages is employed. The need for additional stages increases the capital expenditure (CAPEX) to construct and/or maintain the system and/or increases the footprint of the system. This in turn may limit the locations that such systems can be adopted.

Beneficially, the cooling arrangement 152 prevents or mitigates the detrimental effects which may otherwise result from increases in temperature of the gas, in particular those associated with hydrogen gas.

As shown, the cooling arrangement 152 comprises or take the form of a spray cooling arrangement.

The cooling arrangement 152 is configured and/or operable to direct a cooling fluid F into the first container arrangement 112 and/or the second container arrangement 114.

In use, the cooling arrangement 152 is configured and/or operable to direct the cooling fluid F into whichever of the first container arrangement 112 and the second container arrangement 114 is being utilised to compress the gas G to be pressurised.

In the illustrated apparatus 110, the cooling fluid F comprises or takes the form of cooled compression fluid C. However, it will be understood that the cooling fluid F may alternatively comprise or take the form of another suitable coolant fluid.

In the illustrated apparatus 110, the cooling arrangement 128 is configured and/or operable to direct a continuous spray of the cooling fluid F into the first container 116A when the first container 116A is being operated to compress the gas G to be pressurised or a continuous spray of the cooling fluid F into the second container 116B when the first container 116B is being operated to compress the gas G to be pressurised.

The cooling arrangement 152 is configured and/or operable to increase the volume of cooling fluid F injected into the containers 116A and/or 116B as pressure of the gas G increases as a result of its compression by the compression fluid.

Beneficially, this maintains the isothermal condition of the process.

In the illustrated apparatus 110, the cooling arrangement 152 is also configured and/or operable to seed the cooling fluid F into the second container 116A prior to completion of the compression of the gas G by reaching the target pressure Pt.

Beneficially, this seeding of cooling fluid in the second container 116B facilitates an even distribution of cooling fluid F in the gas G to be pressurised in the second container 116B when the operation switches to the subsequent cycle in which the gas G directed into the second container 116B to fill the space left by the compression fluid C is compressed by compression fluid C directed back from the first container 116A.

As shown in FIGS. 3 and 4, the cooling fluid F is directed into the top of the first container 116A, the first container 116A comprising an inlet arrangement 154A for receiving the cooling fluid F from a source 156 of the cooling fluid F via a fluid conduit 158A. Where the cooling fluid F comprises or takes the form of cooled compression fluid C, the source 156 may be the same source 144 described above. In the illustrated apparatus 110, the inlet arrangement 154A comprises one or more inlets 158A in the form of nozzles.

As shown, the cooling arrangement 152 further comprises a pump 162A and a heat exchanger 164A on the conduit 158A.

As shown in FIGS. 3 and 5, the cooling fluid F is directed into the top of the second container 116B, the first container 116B comprising an inlet arrangement 154B for receiving the cooling fluid F from the source 156 via a fluid conduit 158B. In the illustrated apparatus 110, the inlet arrangement 154B comprises one or more inlets 160B in the form of nozzles.

As shown, the cooling arrangement 152 further comprises a pump 162B and a heat exchanger 164B on the conduit 158B.

It will be recognised that while in the illustrated apparatus 110 a separate pump 162B and heat exchanger 164B are provided, a common pump arrangement and/or heat exchanger arrangement may be utilised for both the first container 116A and the second container 116B.

As shown in FIGS. 3, 4 and 5, the illustrated apparatus 110 comprises a separation arrangement, generally denoted 166.

The separation arrangement 166 is configured and/or operable to separate the gas G to be pressurised from the compression fluid C forming the liquid piston.

In the illustrated apparatus 110, the separation arrangement 166 comprises mechanical separator members 168A, 168B provided in the first and second containers 116A, 116B.

In the illustrated apparatus 110, the first container 116A further comprises an outlet 170A. The outlet 170A is configured and/or operable to directing the cooling fluid F from the first container 116A via a conduit 172A. In the illustrated apparatus 110, the outlet 170A comprises, is coupled to or takes the form of a control valve.

In the illustrated apparatus 110, the second container 116B also further comprises an outlet 170B. The outlet 170B is configured and/or operable to directing the cooling fluid F from the second container 116B via a conduit 172B. In the illustrated apparatus 110, the outlet 170B comprises, is coupled to or takes the form of a control valve.

Operation of the apparatus 110 will now be described with reference to FIGS. 5 to 5 from the standpoint that first container 116A is initially entirely or substantially entirely filled with hydrogen gas G at entry pressure Pe1 and second container 116B is initially entirely or substantially entirely filled with compression fluid C under pressure.

At this stage, the first inlet 120A, first outlet 126A, second inlet 134A and second outlet 138A of the first container 116A are closed as are the first inlet 120B, first outlet 126B, second inlet 134B and second outlet 138B of the second container 116B.

In order to compress the gas G in the first container 116A, the inlet 134A of the first container 116A and the outlet 138B of the second container 116B open, permitting compression fluid C to be communicated from the second container 116B to the first container 116A.

The compression fluid C from container 116B flows out towards the pump 148 due to the initial pressure the compression fluid C is under and a slight hydrostatic pressure which minimised the required pump power.

At the same or substantially the same time as the outlet 138B of the second container 116B opens, the inlet 120B of the second container 116B opens to permit gas at pressure Pe2 to enter the second container 116B when permitted to do so by egress of the compression fluid C from the second container 116B.

Thus, as the compression fluid C is leaving container 116B the increasing open volume in container 116B is being filled with hydrogen flowing in at stage entry pressure Pe2.

As the hydrogen gets compressed in the first container 116A, cooling fluid F—which in the illustrated apparatus 110 is in the form of cold compression fluid—is sprayed in from the top to cool the gas G from the centre where the heat is being generated, enabling a near-isothermal compression process.

The remaining compression fluid C is pumped from container 116B to container 116A to compress the gas G to stage target pressure Pt1, while continuously being cooled via the spray.

It is envisaged that with increasing pressure more spray may be sprayed into the stage to keep the gas temperature constant, thereby keeping the process isothermal.

When the stage target pressure Pt1 has been achieved in container 116A, the outlet valve 126A opens and the gas G at target pressure Pt1 is pushed into the next compression stage while more compression fluid C is pumped in from the bottom of the container 116A.

As the compression fluid C in container 116A approaches its completion the outlets 158B in container 116B may seed a mist of cooling fluid into the further gas entering the second container 116B. The seeding of cooling fluid may allow for an even distribution of cooling fluid right from the start of the compression process.

The valves in both containers 116A, 116B close. The process is then reversed with the process repeating itself in an alternating fashion between the containers 116A, 116B.

As noted above, the present apparatus 110 provides a number of significant benefits over conventional systems and methodologies.

For example, the apparatus 110 facilitates near isothermal compression of the gas to be achieved. The apparatus 110 also obviates the thermal and/or mechanical stresses on the containers which may otherwise reduce the operational life of the containers and/or the system. Moreover, no additional storage capacity for the compression fluid is required, as it is under constant use flowing between the first and second container arrangements.

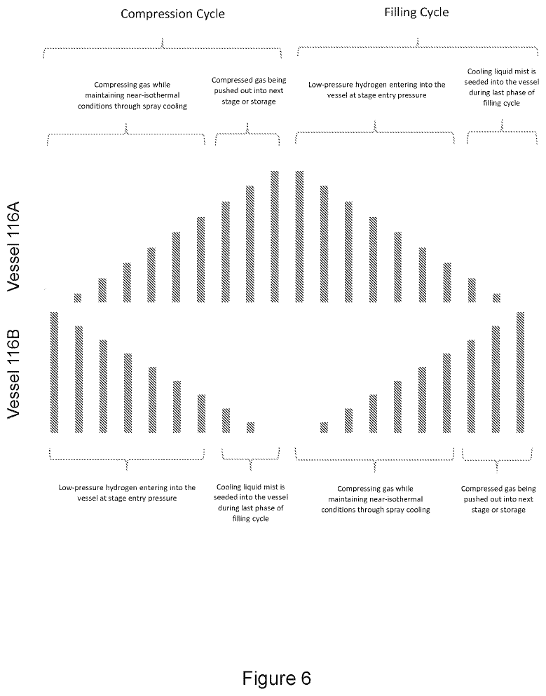

Moreover, the container arrangements 112, 114 of the apparatus 110 are capable of working as a pair during the compression process. This is illustrated diagrammatically in FIG. 6 of the accompanying drawings which illustrates the phase synching of the containers 116A, 116B during the compression process.

It will be understood that various modifications may be made without departing from the scope of the claimed invention.

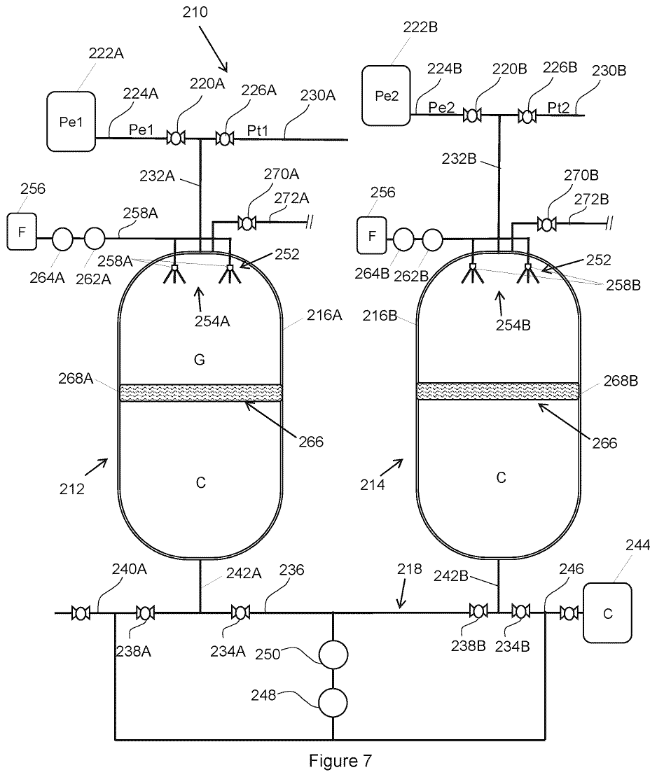

For example, FIG. 7 of the accompanying drawings shows an alternative apparatus 210 for compressing a gas G.

The apparatus 210 is similar to the apparatus 110 and like components are represented by like reference signs.

As shown in FIG. 7, the apparatus 210 comprises a first container arrangement, generally denoted 212 (shown on the left in FIG. 7), and a second container arrangement, generally denoted 214 (shown on the right in FIG. 7). In the illustrated apparatus 210, the first container arrangement 212 comprises a first container 216A and the second container arrangement 214 comprises a second container 216B. The first container 216A is configured to receive and/or contain the gas G to be pressurised. The second container 216B contains and/or is configured to receive compression fluid C. The apparatus 210 further comprises a fluid communication arrangement, generally denoted 218, which is configured to provide fluid communication between the first container 216A and the second container 216B.

As will be described further below, the apparatus 210 is configured and/or operable to direct the compression fluid C from the second container 216B to the first container 216A via the fluid communication arrangement 218, the compression fluid C being incompressible or substantially incompressible so as to form a fluid piston acting on the gas G contained in the first container 216A, thereby compressing the gas G contained in the first container 216A.

In use, the apparatus 210 is operable to direct an incompressible or substantially compression fluid C from the second container arrangement 214 to the first container arrangement 212, the compression fluid C forming a fluid piston acting on the gas G contained in the first container arrangement 212. Movement of the fluid piston reduces the volume and increases the pressure of the gas G contained in the first container 216A, thereby pressurising the gas G from an entry stage pressure Pe1 to a target pressure Pt1.

In some instances, the pressurised gas G at target pressure Pt1 is then directed for storage, transport and/or other handling processes.

Alternatively, the pressurised gas G at target pressure Pt1 may then be directed to a subsequent stage where the pressure of the gas G is further increased.

The apparatus 210 is configured and/or operable to direct a second volume of gas G to be pressurised at entry pressure Pe2, which may be at the same or a different entry pressure to Pe1, into the second container arrangement 214 as the compression fluid C is directed from the second container arrangement 214 to the first container arrangement 212. The further volume of gas G to be pressurised may occupy the volume previously occupied by the compression fluid C in the second container 216B.

It will be recognised that, in use, once the second container arrangement 214 has directed all of the compression fluid C contained therein to the first container arrangement 212 and the second container arrangement 214 is full of the further gas G to be pressurised, the apparatus 210 may be operable in reverse in a subsequent cycle of operation by directing the compression fluid C from the first container arrangement 212 (which in the subsequent cycle constitutes the second container arrangement) to the second container arrangement 214 (which in the subsequent cycle constitutes the first container arrangement).

The present apparatus 210 provides a number of significant benefits over conventional systems and methodologies.

For example, the apparatus 210 facilitates near isothermal compression of the gas to be achieved. The apparatus 210 obviates the requirement to decant between donating and receiving containers and so avoids the thermodynamic inefficiencies associated with conventional techniques. The apparatus 210 also obviates the thermal and/or mechanical stresses on the containers which may otherwise reduce the operational life of the containers and/or the system. Moreover, no additional storage capacity for the compression fluid C is required, as it is under constant use flowing between the first and second container arrangements 212, 214.

The first container 216A comprises a first inlet 220A which is configured and/or operable to act as a gas inlet, e.g. low pressure gas inlet. In the illustrated apparatus 210, the first inlet 220A comprises, is coupled to or takes the form of a control valve and is coupled to a source 222A of gas at entry pressure Pe via a conduit 224A.

The first container 216A comprises a first outlet 226A which is configured and/or operable to act as a gas outlet, e.g. high pressure gas outlet. In use, the first outlet 226A is operable to direct pressurised gas at target pressure Pt1 from the first container 216A. In the illustrated apparatus 210, the first outlet 226A comprises, is coupled to or takes the form of a control valve and controls access to an outlet conduit 230A.

As shown, in the apparatus 210 the first inlet 220A and the first outlet 226A share a common conduit 232A into/out from the first container 216A. However, it will be understood that the first inlet 220A and first outlet 226A may alternatively be directly coupled and/or form part of the first container 216A and/or may be coupled to the first container 216A via separate conduits.

The first container 216A further comprises a second inlet 234A which is configured and/or operable to act as a compression fluid inlet. In use, the second inlet 234A is operable to provide fluid communication of the compression fluid from/to the second container 216B via a fluid conduit 236 of the fluid communication arrangement 218. In the illustrated apparatus 210, the second inlet 234A comprises, is coupled to or takes the form of a control valve.

The first container 216A further comprises a second outlet 238A which is configured and/or operable to act as a compression fluid outlet. In use, the second outlet 238A is operable to provide fluid communication of the compression fluid (and, where applicable, cooling fluid as will be described below) from the first container 216A via second container 216B via a fluid conduit 240A. In the illustrated apparatus 210, the second outlet 238A comprises, is coupled to or takes the form of a control valve.

As shown, in the apparatus 210 the second inlet 234A and the second outlet 238A share a common conduit 242A into/out from the first container 216A. However, it will be understood that the second inlet 234A and second outlet 238A may alternatively be directly coupled and/or form part of the first container 216A and/or may be coupled to the first container 216A via separate conduits.

The second container 216B comprises a first inlet 220B which is configured and/or operable to act as a gas inlet, e.g. low pressure gas inlet. In the illustrated apparatus 210, the first inlet 220B comprises, is coupled to or takes the form of a control valve and is coupled to a source 222B of gas at entry pressure Pe2 via a conduit 224B.

The second container 216B comprises a first outlet 226B which is configured and/or operable to act as a gas outlet, e.g. high pressure gas outlet. In use, the first outlet 226B is operable to direct pressurised gas at target pressure Pt2 from the second container 216B.

In the illustrated apparatus 210, the first outlet 226B comprises, is coupled to or takes the form of a control valve and controls access to an outlet conduit 230B.

As shown, in the illustrated apparatus 210 the first inlet 220B and the first outlet 226B share a common conduit 232B into/out from the second container 216B. However, it will be understood that the first inlet 220B and the first outlet 226B may alternatively be directly coupled and/or form part of the second container 216B and/or may be coupled to the second container 216B via separate conduits.

The second container 216B further comprises a second inlet 234B which is configured and/or operable to act as a compression fluid inlet. In the illustrated apparatus 210, the second inlet 234B comprises, is coupled to or takes the form of a control valve and is coupled to a source 244 of compression fluid C via a fluid conduit 246.

The second container 216B further comprises a second outlet 238B which is configured and/or operable to act as a compression fluid outlet. In use, the second outlet 238B is operable to provide fluid communication of the compression fluid C (and, where applicable, cooling fluid as will be described below) from the second container 216B to the first container 216A.

In the illustrated apparatus 210, the second inlet 234B and the second outlet 238B share a common conduit 242B into/out from the second container 216B. However, it will be understood that the second inlet 234B and second outlet 238B may alternatively be directly coupled and/or form part of the first container 216B and/or may be coupled to the first container 216B via separate conduits.

As noted above, once the second container arrangement 214 has directed all of the compression fluid C contained therein to the first container arrangement 212 and the second container arrangement 212 is full of the further gas to be pressurised, the apparatus 210 may be operable in reverse in a subsequent cycle of operation by directing the compression fluid C from the first container arrangement 212 (which in the subsequent cycle constitutes the second container arrangement) to the second container arrangement 214 (which in the subsequent cycle constitutes the first container arrangement).

Thus, it will be recognised that in this alternate mode the second outlet 238B acts as the second inlet.

As shown, the illustrated apparatus 210 further comprises a pump 248 and a heat exchanger 250 on the conduit 236.

As shown, the apparatus 210 further comprises a cooling arrangement, generally denoted 252.

As described above, conventional techniques for the compression of a gas result in increase in temperature of the gas. For example, the use of piston compressors results in significant temperature increases in the gas being compressed. Given hydrogen's relatively low self-ignition temperature, from a safety perspective, it is required to intercool the gas between compression stages. The requirement to intercool the gas limits the compression ratio that can be achieved at any given stage, requiring that a greater number of stages is employed. The need for additional stages increases the capital expenditure (CAPEX) to construct and/or maintain the system and/or increases the footprint of the system. This in turn may limit the locations that such systems can be adopted.

Beneficially, the cooling arrangement 252 prevents or mitigates the detrimental effects which may otherwise result from increases in temperature of the gas, in particular those associated with hydrogen gas.

As shown, the cooling arrangement 252 comprises or take the form of a spray cooling arrangement.

The cooling arrangement 252 is configured and/or operable to direct a cooling fluid F into the first container arrangement 212 and/or the second container arrangement 214.

In use, the cooling arrangement 252 is configured and/or operable to direct the cooling fluid F into whichever of the first container arrangement 212 and the second container arrangement 214 is being utilised to compress the gas G to be pressurised.

In the illustrated apparatus 210, the cooling fluid F comprises or takes the form of cooled compression fluid C. However, it will be understood that the cooling fluid F may alternatively comprise or take the form of another suitable coolant fluid.

In the illustrated apparatus 210, the cooling arrangement 228 is configured and/or operable to direct a continuous spray of the cooling fluid F into the first container 216A when the first container 216A is being operated to compress the gas G to be pressurised or a continuous spray of the cooling fluid F into the second container 216B when the first container 216B is being operated to compress the gas G to be pressurised.

The cooling arrangement 252 is configured and/or operable to increase the volume of cooling fluid F injected into the containers 216A and/or 216B as pressure of the gas G increases as a result of its compression by the compression fluid.

Beneficially, this maintains the isothermal condition of the process.

In the illustrated apparatus 210, the cooling arrangement 252 is also configured and/or operable to seed the cooling fluid F into the second container 216B prior to completion of the compression of the gas G by reaching the target pressure Pt.

Beneficially, this seeding of cooling fluid in the second container 216B facilitates an even distribution of cooling fluid F in the gas G to be pressurised in the second container 216B when the operation switches to the subsequent cycle in which the gas G directed into the second container 216B to fill the space left by the compression fluid C is compressed by compression fluid C directed back from the first container 216B.

As shown, the cooling fluid F is directed into the top of the first container 216A, the first container 216A comprising an inlet arrangement 254A for receiving the cooling fluid F from a source 256 of the cooling fluid F via a fluid conduit 258A. Where the cooling fluid F comprises or takes the form of cooled compression fluid C, the source 256 may be the same source 244 described above. In the illustrated apparatus 210, the inlet arrangement 254A comprises one or more inlets 260A in the form of nozzles.

As shown, the cooling arrangement 252 further comprises a pump 262A and a heat exchanger 264A on the conduit 258A.

As shown, the cooling fluid F is directed into the top of the second container 216B, the first container 216B comprising an inlet arrangement 254B for receiving the cooling fluid F from the source 256 via a fluid conduit 258B. In the illustrated apparatus 210, the inlet arrangement 254B comprises one or more inlets 260B in the form of nozzles.

As shown, the cooling arrangement 252 further comprises a pump 262B and a heat exchanger 264B on the conduit 258B.

It will be recognised that while in the illustrated apparatus 210 a separate pump 262B and heat exchanger 264B are provided, a common pump arrangement and/or heat exchanger arrangement may be utilised for both the first container 216A and the second container 216B.

As noted above, the illustrated apparatus 210 also comprises a separation arrangement, generally denoted 266.

The separation arrangement 266 is configured and/or operable to separate the gas G to be pressurised from the compression fluid C forming the liquid piston.

In the illustrated apparatus 210, however, the separation arrangement 266 comprises or take the form of a chemical separator provided in the first and second containers 216A, 216B.

In the illustrated apparatus 210, the first container 216A further comprises an outlet 270A. The outlet 270A is configured and/or operable to directing the cooling fluid F from the first container 216A via a conduit 272A. In the illustrated apparatus 210, the outlet 270A comprises, is coupled to or takes the form of a control valve.

In the illustrated apparatus 210, the second container 216B also further comprises an outlet 270B. The outlet 270B is configured and/or operable to directing the cooling fluid F from the second container 216B via a conduit 272B. In the illustrated apparatus 210, the outlet 270B comprises, is coupled to or takes the form of a control valve.

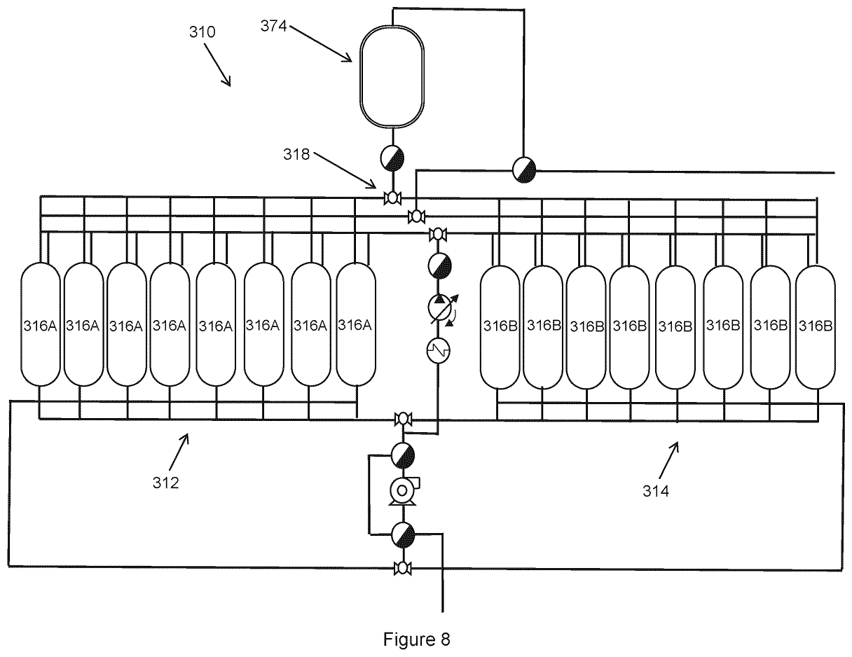

An alternative apparatus, generally denoted 310, is shown in FIG. 8 of the accompanying drawings.

As shown in FIG. 8, the apparatus 310 comprises a first container arrangement, generally denoted 312 and a second container arrangement, generally denoted 314. Whereas the apparatus'110, 210 comprises a single first container 116A,216A and a single second container 116B,216B, in the apparatus 310 there are a plurality of first containers 316A and a plurality of second containers 316B. In the illustrated apparatus 310, there is provided 8 first containers 316A and 8 second containers 316B. In the illustrated apparatus 310, the plurality of first containers 316A are arranged in series and the plurality of second containers 316B are arranged in series.

The apparatus 310 further comprises a fluid communication arrangement, generally denoted 318, which is configured to provide fluid communication between the first containers 316A and the second containers 316B. The first containers 316A is configured to receive the gas G to be pressurised. The second containers 316B are configured to receive compression fluid C.

As will be described further below, the apparatus 310 is configured and/or operable to direct the compression fluid C from the first containers 316A to the second containers 316B via the fluid communication arrangement 318, the compression fluid C being incompressible or substantially incompressible so as to form a fluid piston acting on the gas G contained in the second containers 316B, thereby compressing the gas G contained in the second container 316B.

In use, the apparatus 310 is operable to direct an incompressible or substantially incompressible compression fluid C from the first container arrangement 312 to the second container arrangement 314, the compression fluid C forming a fluid piston acting on the gas G contained in the second container arrangement 314. Movement of the fluid piston reduces the volume and increases the pressure of the gas G contained in the second container arrangement 314, thereby pressurising the gas G from an entry stage pressure Pe to a target pressure Pt at which it is desired to transport and/or otherwise handle the gas G.

It will be recognised that, in use, once the first container arrangement 312 has directed all of the compression fluid C contained therein to the second container arrangement 314 and the first container arrangement 312 is full of the further gas G to be pressurised, the apparatus 310 may be operable in reverse in a subsequent cycle of operation by directing the compression fluid C from the second container arrangement 314 (which in the subsequent cycle constitutes the first container arrangement) to the first container arrangement 312 (which in the subsequent cycle constitutes the second container arrangement).

As shown in FIG. 8, the apparatus 310 comprises a buffer tank, generally denoted 374. The buffer tank 374 is configured and/or operable to contain a supply of compression fluid C.

As described above, various modifications may be made without departing from the scope of the invention.

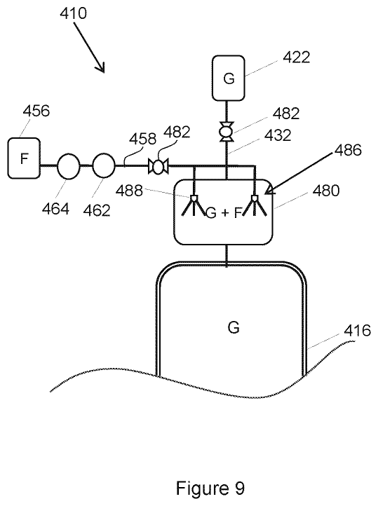

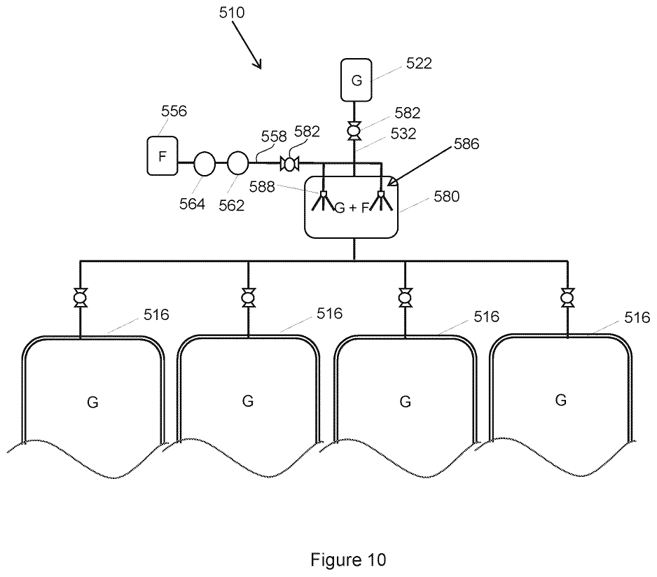

FIGS. 9 and 10 of the accompanying drawings show alternative apparatus' 410, 510 in which the gas G and cooling fluid F are pre-mixed in a manifold, generally denoted 480 in FIGS. 9 and 580 in FIG. 10.

As shown in FIG. 9, gas G is supplied to container 416 from source 422 to the manifold 480 via conduit 432. Flow of the gas G to the manifold 480 is controlled by valve 482. In the illustrated apparatus 410, the valve 482 comprises, is coupled to or takes the form of a control valve. Cooling fluid F is directed from source 456 to the manifold 480 via fluid conduit 458. Flow of the cooling fluid F is controlled by valve 484. In the illustrated apparatus 410, the cooling fluid enters the manifold 480 via inlet arrangement, generally denoted 486. In the illustrated apparatus 410, the inlet arrangement 486 comprises one or more inlets 486 in the form of nozzles.

As shown, the apparatus 410 further comprises a pump 462 and a heat exchanger 464 on conduit 458.

As shown in FIG. 10, gas G is supplied to a plurality of containers 516 from source 522 to the manifold 580 via conduit 532. Flow of the gas G to the manifold 580 is controlled by valve 582. In the illustrated apparatus 510, the valve 582 comprises, is coupled to or takes the form of a control valve. Cooling fluid F is directed from source 556 to the manifold 580 via fluid conduit 558. Flow of the cooling fluid F is controlled by valve 584. In the illustrated apparatus 510, the cooling fluid enters the manifold 580 via inlet arrangement, generally denoted 586. In the illustrated apparatus 510, the inlet arrangement 586 comprises one or more inlets 586 in the form of nozzles.

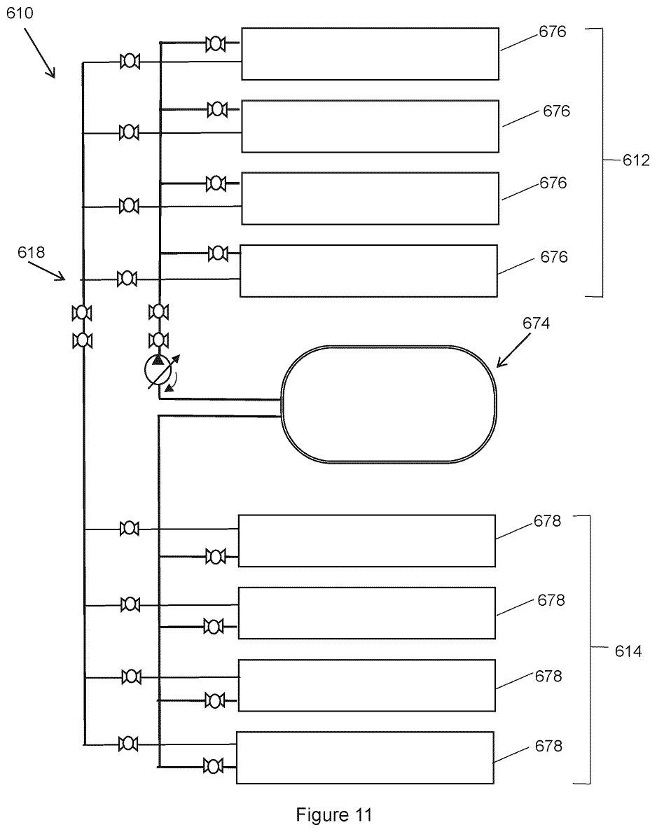

As described above, and referring now to FIGS. 11 to 16 of the accompanying drawings, other aspects of the present disclosure relate to an apparatus, system and method for transferring a pressurised gas.

FIG. 11 shows an apparatus 610 transferring a pressurised gas from a donator container, e.g. a hydrogen storage hub, to a receiver container, e.g. a transport vehicle such as a tube trailer.

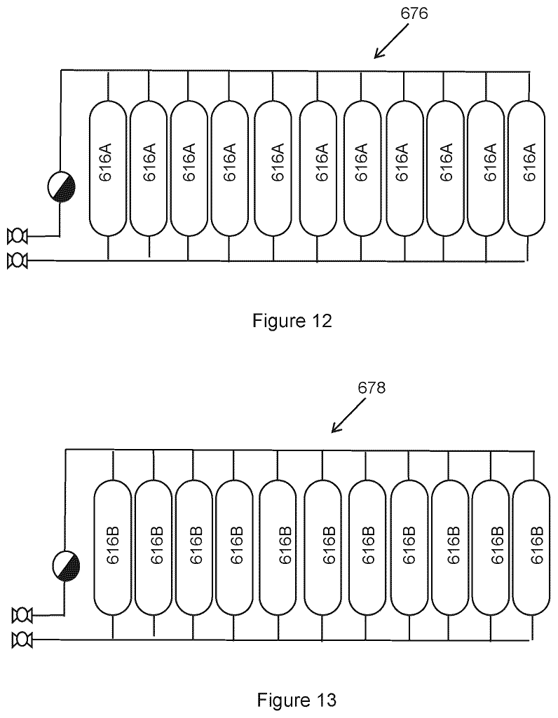

As shown in FIG. 11, the apparatus 610 comprises a first container arrangement, generally denoted 612, comprising one or more first containers 616A (shown in FIG. 12). In the illustrated apparatus 610, the first container arrangement 612 comprises a plurality of modules 676 arranged in parallel, each containing a plurality of containers 616A connected in series. However, it will be understood that the containers 616A may be arranged in a variety of configurations.

The first container arrangement 612 is configured and/or operable in a first mode to act as donator for the pressurised gas G.

The apparatus 610 further comprises a second container arrangement, generally denoted 614, comprising one or more second containers 616B (shown in FIG. 13). In the illustrated apparatus 610, the second container arrangement 614 comprises a plurality of modules 678 arranged in parallel, each containing a plurality of containers 616B connected in series. However, it will be understood that the containers 616B may be arranged in a variety of configurations.

The second container arrangement 614 is configured and/or operable in a first mode to act as a receiver for the pressurised gas G.

A fluid communication arrangement 618 is provided, the fluid communication arrangement 618 configured to provide fluid communication between the first container arrangement 612 and the second container arrangement 614.

As shown, the apparatus 610 comprises a compression fluid buffer tank 674. The buffer tank 674 is located at the storage site. This enables a complete filling and emptying process, enabling e.g. tube trailers to deliver their entire load, which enhance the systematic efficiency as well as minimises fuel consumption.

The apparatus 610 is configured and/or operable to direct compression fluid C from the receiver, in this case the second container arrangement 614, to the first container arrangement 612 via said fluid communication arrangement 618. The compression fluid C is incompressible or substantially incompressible so as to form a fluid piston acting on the gas G contained in the first container arrangement 612, thereby transferring the pressurised gas G from the first container arrangement 612 to the second container arrangement 614.

Beneficially, near loss-less gas transfer is enabled by keeping the gas at target pressure Pt during the transfer process. This is enabled by prefilling the receiving container with compression fluid C. In use, the receiving container is pressurised to the pressure level of incoming gas G. Given that the compression fluid C is effectively incompressible the work from the pump to create this pressure is considered to be small. A minimal pressure drop may occur due to the gas G in the receiving conduit being at a lower pressure than the donating container.

Once the pressure in the receiving container is increased by the required, small, amount, the connection for the gas flow from the donating container to the receiving container is opened. At this stage, the pump is operable to pump the compression fluid that has been pre-filled into the receiving container from there into the donating container. As the compression fluid is pumped back it pushes the gas G into the receiving container. This process continues until the entire volume of the compression fluid C is displaced with high pressure gas G.

The pump pressurises the fluid. Once the fluid is compressed and the valves are opened the pump is no longer required to create pressure, as the circuit is now under relatively uniform (high) pressure. The role of the pump at this stage is to create motion, effectively swapping fluid and gas in their positions. To do so, the pump delivers the required work to overcome a small resistance in the pipework and valve connections.

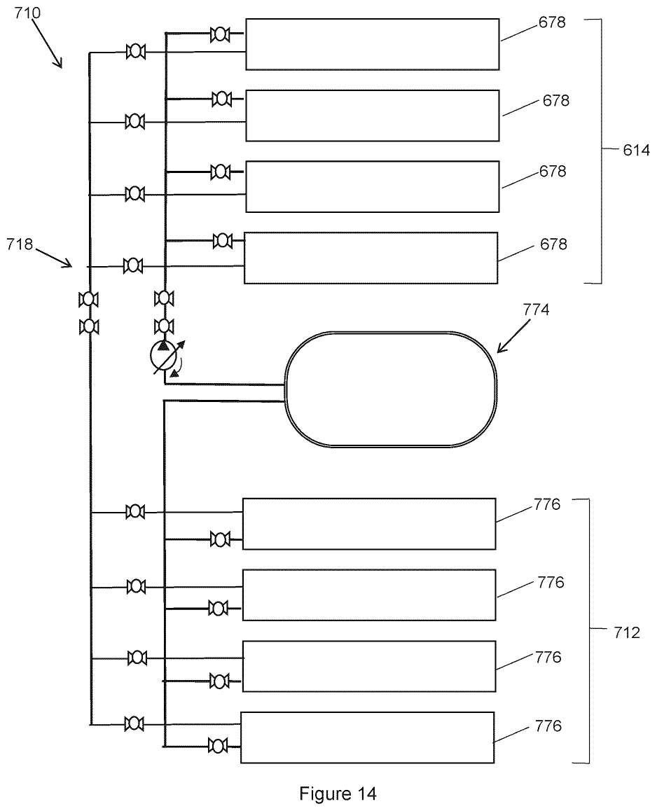

FIG. 14 shows an apparatus 710 transferring a pressurised gas from a donator container, e.g. the transport vehicle which in the apparatus 610 was the receiver, to a receiver container, e.g. a local storage facility.

As shown in FIG. 14, the apparatus 710 comprises container arrangement 614 (shown in FIG. 11) and a second container arrangement 712 which acts as a receiver, e.g. located at a local storage facility.

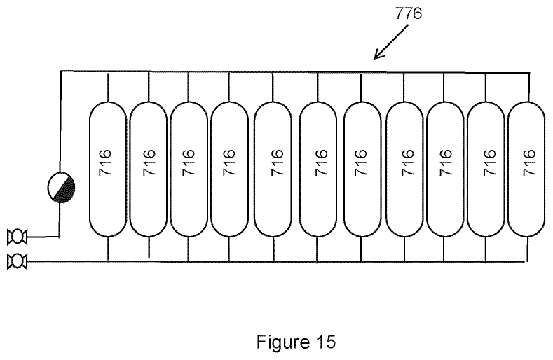

The second container arrangement 712 comprises one or more containers. In the illustrated apparatus 710, the container arrangement 712 comprises a plurality of modules 776 (one of which is shown in FIG. 15) arranged in parallel, each containing a plurality of the containers 716 connected in series. However, it will be understood that the containers 716 may be arranged in a variety of configurations.

A fluid communication arrangement 718 is provided, the fluid communication arrangement 718 configured to provide fluid communication between the first container arrangement 612 and the second container arrangement 712.

As shown, the apparatus 710 comprises a compression fluid buffer tank 774. The buffer tank 774 is located at the storage site. This enables a complete filling and emptying process, enabling e.g. tube trailers to deliver their entire load, which enhance the systematic efficiency as well as minimises fuel consumption.

The apparatus 710 is configured and/or operable to direct compression fluid C from the receiver, in this case the container arrangement 712, to the container arrangement 614 via said fluid communication arrangement 718. The compression fluid C is incompressible or substantially incompressible so as to form a fluid piston acting on the gas G contained in the container arrangement 614, thereby transferring the pressurised gas G from the container arrangement 614 to the container arrangement 712.

Beneficially, near loss-less gas transfer is enabled by keeping the gas at target pressure Pt during the transfer process. This is enabled by prefilling the receiving container with compression fluid C. As the compression fluid C is substantially non-compressible the container only needs to have a relatively small amount of pump work resulting in high pressure increase applied. A minimal pressure drop may occur due to the gas G in the receiving conduit being at a lower pressure than the donating container.

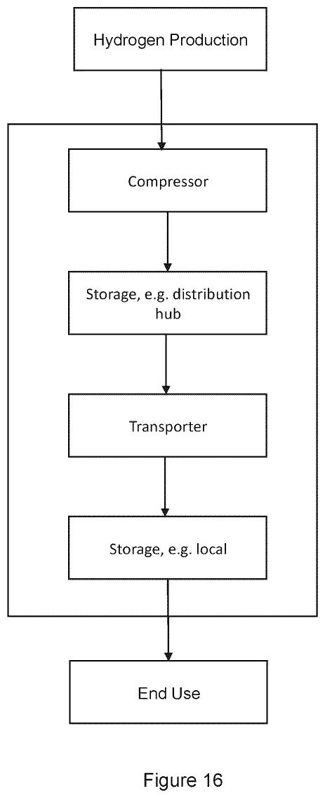

It will be recognised that the present disclosure may form a system, illustrated diagrammatically in FIG. 16, for compressing and transporting pressurised gas, e.g. hydrogen.

1. A system for compressing and transferring a pressurised gas, comprising:
an apparatus for compressing a gas, comprising:
a first container arrangement comprising one or more first containers,
wherein the first container arrangement is configured to receive and/or store a gas to be pressurised;
a fluid communication arrangement configured to provide fluid communication between a source of compression fluid and the first container arrangement,
wherein:
the apparatus is configured and/or operable to direct the compression fluid to the first container arrangement via said fluid communication arrangement, the compression fluid being incompressible or substantially incompressible so as to form a fluid piston acting on the gas contained in the first container arrangement, thereby compressing the gas contained in the first container arrangement to produce a pressurised gas to be transferred; and
the apparatus is configured and/or operable to direct compression fluid to the first container arrangement via said fluid communication arrangement, the compression fluid being incompressible or substantially incompressible so as to form a fluid piston acting on the pressurised gas contained in the first container arrangement, thereby transferring the pressurised gas from the first container arrangement.

2. The system of claim 1, wherein the apparatus comprises a second container arrangement, the second container arrangement configured to receive and/or store the compression fluid, and wherein the apparatus is configured and/or operable to direct the compression fluid from the second container arrangement to the first container arrangement via said fluid communication arrangement so as to pressurise the gas in or transfer the pressurised gas from the first container arrangement.

3. The system of claim 1, wherein the apparatus is configured and/or operable to direct a second volume of gas to be pressurised into the second container arrangement e.g. as the compression fluid is directed from the second container arrangement to the first container arrangement, the second volume of gas to be pressurised occupying the volume previously occupied by the compression fluid in the second container arrangement.

4. The system of claim 1, wherein the first container arrangement comprises a plurality of the first containers, at least two of the first containers being arranged and/or fluidly connected in series.

5. The system of claim 1, wherein the first container arrangement comprises a plurality of the first containers, at least two of the first containers being arranged and/or fluidly connected in parallel.

6. The system of claim 1, wherein one or more of the first containers comprises at least one of:
a first inlet, the first inlet configured and/or operable to act as a gas inlet;
a first outlet, the first outlet configured and/or operable to act as a gas outlet;
a second inlet, the second inlet configured and/or operable to act as a compression fluid inlet; and
a second outlet, the second outlet configured and/or operable to act as a compression fluid outlet.

7. The system of claim 2, wherein the second container arrangement comprises a plurality of the second containers, at least two of the second containers being arranged and/or fluidly connected in series.

8. The system of claim 2, wherein the second container arrangement comprises a plurality of the second containers, at least two of the second containers being arranged and/or fluidly connected in parallel.

9. The system of claim 2, wherein one or more of the second containers comprises at least one of:
a first inlet, the first inlet configured and/or operable to act as a gas inlet;
a first outlet, the first outlet configured and/or operable to act as a gas outlet;
a second inlet, the second inlet configured and/or operable to act as a compression fluid inlet; and
a second outlet, the second outlet configured and/or operable to act as a compression fluid outlet.

10. The system of claim 2, wherein the apparatus comprises, is coupled to or operatively associated with a cooling arrangement.

11. The system of claim 10, wherein the cooling arrangement is configured and/or operable to direct a cooling fluid into the first container arrangement.

12. The system of claim 11, wherein at least one of:
the cooling arrangement comprises or takes the form of a spray cooling configured and/or operable to direct the cooling fluid into the first container arrangement;
the cooling arrangement is configured and/or operable to direct the fluid into the first container arrangement to form a layer, e.g. film, of cooling fluid on the interior surface of one or more of the first containers of the first container arrangement.

13. The system of claim 10, wherein the cooling fluid is directed into the top or a top portion or an area of the fluid conduit ahead of the entry into the container of one or more of the first containers of the first container arrangement.

14. The system of claims 10, wherein the apparatus comprises a second container arrangement, the second container arrangement configured to receive and/or store the compression fluid, and wherein the apparatus is configured and/or operable to direct the compression fluid from the second container arrangement to the first container arrangement via said fluid communication arrangement so as to pressurise the gas in or transfer the pressurised gas from the first container arrangement, and wherein the cooling arrangement is configured and/or operable to direct a cooling fluid into the second container arrangement.

15. The system of claim 14, wherein at least one of:
the cooling arrangement comprises or takes the form of a spray cooling configured and/or operable to direct the cooling fluid into the second container arrangement;
the cooling arrangement is configured and/or operable to direct the fluid into the second container arrangement to form a layer, e.g. film, of cooling fluid on the interior surface of one or more of the second containers of the second container arrangement.

16. The system of claim 14, wherein the cooling fluid is directed into the top or a top portion of one or more of the second containers of the second container arrangement.

17. The system of claim 14, wherein the cooling arrangement is configured and/or operable to seed the cooling fluid into the second container arrangement prior to completion of the compression of the gas in the first container arrangement.

18. The system of claim 10, wherein the cooling fluid comprises or takes the form of the compression fluid, e.g. cooled compression fluid.

19. The system of claim 1, wherein the apparatus is configured and/or operable so that the gas to be pressurised is supplied directly into one or more of the first containers of the first container arrangement.

20. The system of claim 1, wherein the apparatus is configured and/or operable so that the gas to be pressurised is supplied indirectly into one or more of the first containers of the first container arrangement via a manifold.

21. The system of claim 20, wherein the cooling arrangement is configured and/or operable to direct a cooling fluid into the first container arrangement, and wherein the apparatus is configured and/or operable so that the cooling fluid is supplied indirectly into one or more of the first containers of the first container arrangement via the manifold.

22. The system of claim 2, wherein the apparatus is configured and/or operable so that the gas to be pressurised is supplied directly into one or more of the second containers of the second container arrangement.

23. The system of claim 2, wherein the apparatus is configured and/or operable so that the gas to be pressurised is supplied indirectly into one or more of the second containers of the second container arrangement via a manifold.

24. The system of claim 23, wherein the cooling arrangement is configured and/or operable to direct a cooling fluid into the first container arrangement, and wherein the apparatus is configured and/or operable so that the cooling fluid is supplied indirectly into one or more of the second containers of the second container arrangement via the manifold.

25. The system of claim 11, wherein the apparatus comprises:
one or more cooling fluid inlets; and/or
one or more cooling fluid outlets.

26. The system of claim 1, wherein the apparatus comprises a separation arrangement, the separation arrangement configured and/or operable to separate the gas to be pressurised from the compression fluid forming the liquid piston.

27. The system of claim 26, wherein the separation arrangement comprises or takes the form of a mechanical separator member.

28. The system of claim 26, wherein the separation arrangement comprises or takes the form of a chemical separator.

29. A method for compressing and transferring a gas, using the system of claim 1.
